(19) United States
(12) Patent Application Publication
(10) Pub. No.: US 2013/0019046 A1
(43) Pub. Date: Jan. 17, 2013

(54) DATA TRANSMITTING DEVICE AND SYSTEM FOR PORTABLE DEVICE AND METHOD THEREOF

(71) Applicants: Yeong-Ruey SHIEH, Hsinchu City (TW); Shih-Keng Cho, Hsinchu City (TW); Hsu-Pin Liu, Hsinchu City (TW); Wei-Shu Hsu, Hsinchu City (TW); Chi-Han Lin, Hsinchu City (TW); Yu-Shiang Wang, Hsinchu City (TW)

(72) Inventors: Yeong-Ruey SHIEH, Hsinchu City (TW); Shih-Keng Cho, Hsinchu City (TW); Hsu-Pin Liu, Hsinchu City (TW); Wei-Shu Hsu, Hsinchu City (TW); Chi-Han Lin, Hsinchu City (TW); Yu-Shiang Wang, Hsinchu City (TW)

(73) Assignee: SKYMEDI CORPORATION

(21) Appl. No.: 13/184,162

(22) Filed: Jul. 15, 2011

(51) Int. Cl. G06F 13/00

(52) U.S. Cl. 710/316

(57) ABSTRACT

A data transmitting method for communicating one of a plurality of portable devices with a host computer via a data transmitting device having a plurality of USB connector is disclosed. In one embodiment of the present invention, the method includes the following steps: firstly, a switch circuit is configured in one of the portable devices. Then, the portable device having the switch circuit is coupled with the data transmitting device. Afterward, a data transmission path between the host computer and the portable device having the switch circuit is connected by the switch circuit to transmit data between the portable device having the switch circuit and the host computer, or the data transmission path between the USB connector, which is not connecting with the portable device having the switch circuit, and the host computer is connected by the switch circuit.

### BACKGROUND OF THE INVENTION

1. Field of the Invention

The present invention generally relates to a data transmitting device and system, and more particularly to a data transmitting device and system for communicating with a portable device and method thereof.

2. Description of Related Art

Hand-held devices or portable devices, such as a USB device, not only can be used to transfer data, but also can be used to perform charging by plugging the device in the interface connecting port (e.g., USB connecting port) of a computer. However, this has the limitation of the number of USB devices communicating with the USB connecting port of the computer. In order to communicate with the computer for more hand-held devices, the USB hub is developed to connect the hand-held devices and the computer.

Referring now to FIG. 1, an architecture diagram illustrating the traditional data transmitting system for portable device according to an embodiment is shown. The data transmitting system 1 includes a host computer 11 and a USB hub 13. The USB hub 13 includes a plurality of sub-connecting ports 131 which are provided plural portable devices 15 to plug in to interact with the host computer 11. The host computer 11 includes a USB connecting port 111 which is configured to connect the USB hub 13 and the host computer 11. The host computer 11 can connect plural portable devices 15 at the same time to perform data transmission or supply power via the USB hub 13.

Although the host computer 11 can connect plural portable devices 15 at the same time based on the scheme in FIG. 1, the host computer 11 communicates with only one of the portable devices 15 at a time in certain application; therefore, the USB hub solution not only consumes lots of power, but also increases the circuit complexity and design cost.

In view of the above drawbacks, a need has arisen to propose a novel data transmitting system for portable device and method thereof to save power consumption and design cost.

### SUMMARY OF THE INVENTION

In view of the foregoing, it is an object of the embodiment of the present invention to provide a data transmitting device and system and method for communicating a portable device with a host computer, which utilizes switch circuit to switch data transmitting path, so as to simplify the control mechanism for the communication between a USB interface of the host computer and the USB portable devices.

According to one embodiment, a data transmitting device is provided. The data transmitting device includes a first USB connector, at least one second USB connector and a first portable device. The first USB connector is used to connect with a host computer. The first portable device, coupling with the first USB connector and the second USB connector, includes a switch circuit and a switch. The switch is configured to generate a control signal to the switch circuit, so as to connect the data transmission path between the first portable device and the host computer or connect the data transmission path between the second USB connector and the host computer.

According to another embodiment, a data transmitting system for communicating with one of USB portable devices is provided. The data transmitting system includes a data transmitting device and a first portable device. The data transmitting device includes a first USB connector, used to connect with a host computer, and at least one second USB connector. The first portable device, coupled with the data transmitting device, includes a first switch circuit and a first switch. The first switch configured to generate a first control signal to the first switch circuit, so as to connect or disconnect the data transmission path between the first portable device and the host computer.

According to another embodiment, a data transmitting method for communicating one of a plurality of portable devices with a host computer via a data transmitting device having a plurality of USB connectors is disclosed. The method comprises the following steps: firstly, a switch circuit is configured in each of the portable devices. Then, at least one of the portable devices is coupled to the host computer by connecting the at least one of the portable devices to one of the USB connectors of the data transmitting device. Afterward, at least one data transmission path between the host computer and the portable devices is connected by the switch circuits of the portable devices. Data between the portable device and the host computer is transmitted when only one data transmission path between the host computer and the portable device is connected by the switch circuit of the portable device. The USB connectors of the data transmitting device could be the USB host connectors, the USB device connectors or the combination thereof.

According to another embodiment, a data transmitting method for communicating one of a plurality of portable devices with a host computer via a data transmitting device having a plurality of USB connectors is disclosed. The method comprises the following steps: firstly, a switch circuit is configured in one of the portable devices. Then, the portable device having the switch circuit is coupled with the data transmitting device. Afterward, a data transmission path between the host computer and the portable device having the switch circuit is connected by the switch circuit to transmit data between the portable device having the switch circuit and the host computer, or the data transmission path between the USB connector, which is not connecting with the portable device having the switch circuit, and the host computer is connected by the switch circuit.

### BRIEF DESCRIPTION OF THE DRAWINGS

FIG. 1 shows an architecture diagram illustrating the traditional data transmitting system for portable device according to an embodiment;

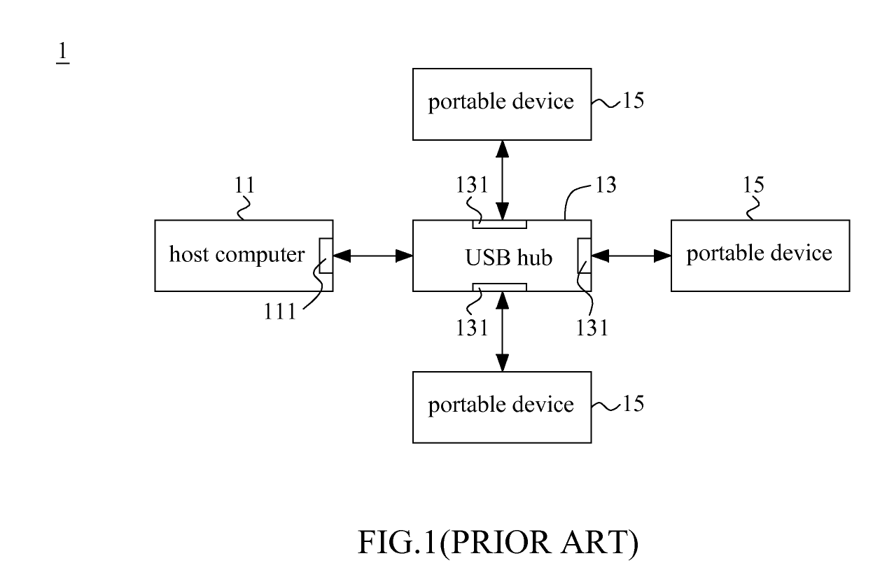

FIG. 2 shows an architecture diagram illustrating a data transmitting system for portable device according to one embodiment of the present invention;

FIG. 3 illustrates a circuit diagram of the data transmitting system of FIG. 2 according to one embodiment of the present invention;

FIG. 4 shows an architecture diagram illustrating a data transmitting system for portable device according to another embodiment of the present invention;

FIG. 5 illustrates a circuit diagram of the data transmitting system of FIG. 4 according to one embodiment of the present invention; and.

FIG. 6 shows a flow diagram illustrating a data transmitting method for portable device according to one embodiment of the present invention.

### DETAILED DESCRIPTION OF THE INVENTION

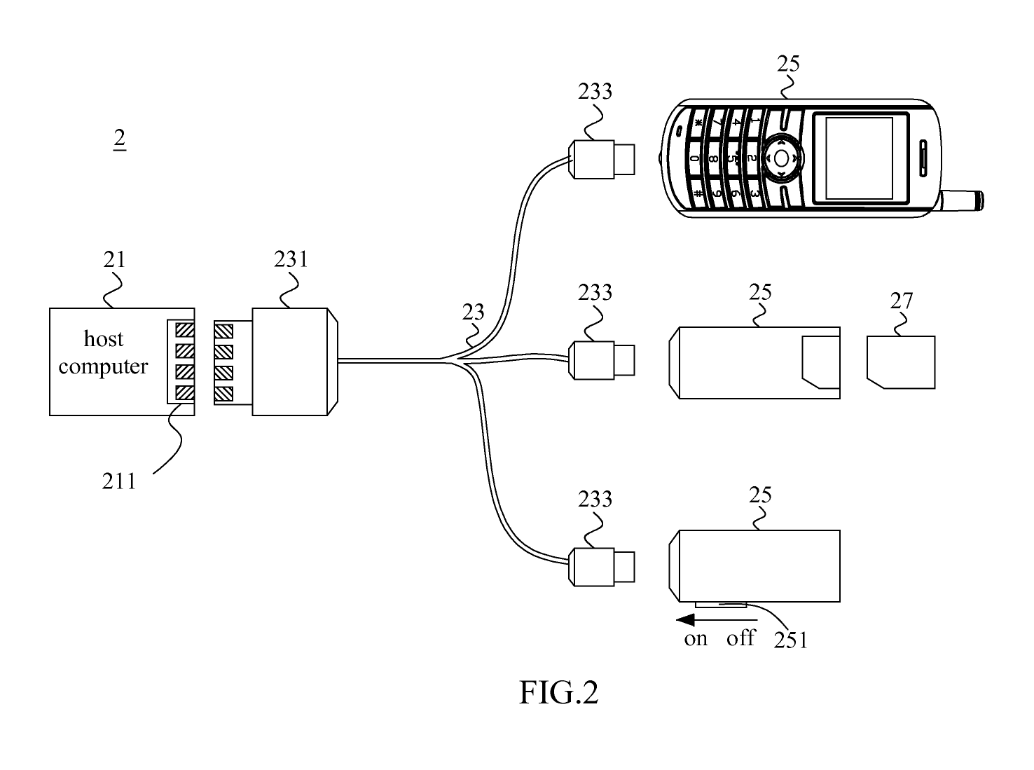

Referring now to FIG. 2, an architecture diagram illustrating a data transmitting system 2 for portable device according to one embodiment of the present invention is shown. As illustrated, the data transmitting system 2 includes a data transmitting device 23 and a plurality of portable devices 25. The data transmitting device 23 has a (first) USB connector 231 which is used to connect with a host computer 21 and plural (second) USB connectors 233 used to connect with the portable devices 25. The USB connector 231 and the USB connector 233 individually could be the USB host connector or the USB device connector. The host computer 21 includes a USB connector 211 which is provided, the portable device 25 to plug in directly to interact with the host computer 21. In another embodiment, plural portable devices 25 may be connected to the USB connectors 233 to couple to the host computer 21 via the data transmitting device 23, so as to obtain electricity provided by the host computer 21 or transmit data with the host computer 21. Specifically, the host computer 21 comprises a personal computer (PC) or a notebook computer. The portable devices 25 comprise mobile phones, personal digital assistants (PDAs), card readers, USB mouses, USB flash disks (UFD) or the combination thereof. The USB connector 211, 231, 233 may be a USB 2.0 or USB 3.0 connecting port.

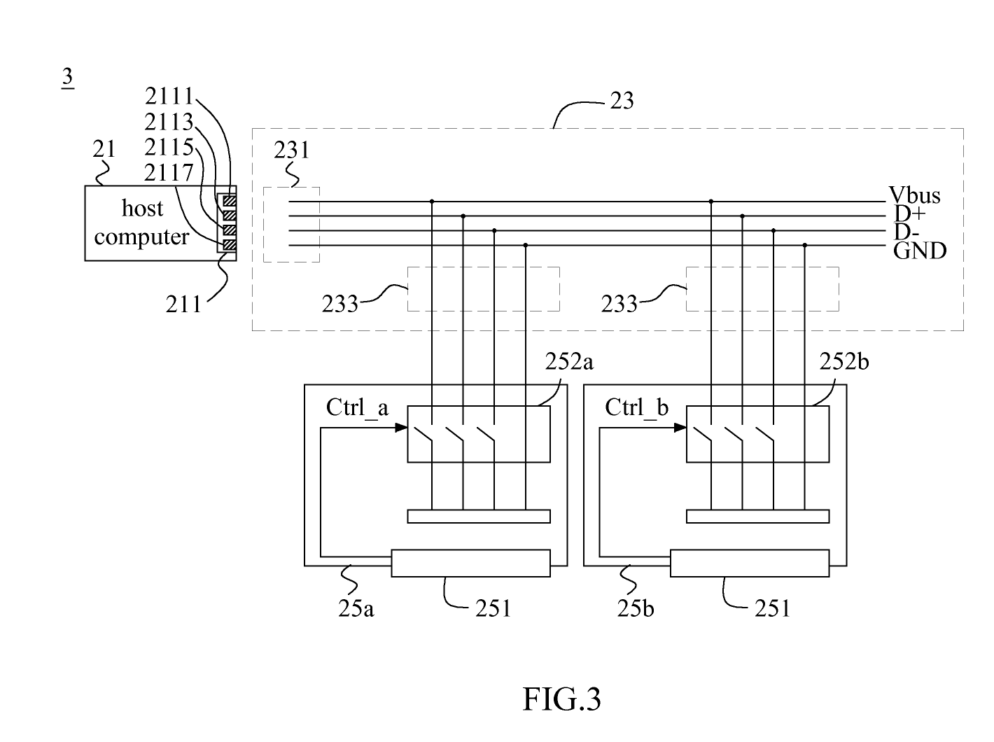

Please refer to FIG. 3 as well, which illustrates a circuit diagram of the data transmitting system 2 of FIG. 2 according to one embodiment of the present invention. As shown in FIG. 3, the USB connector 211 of the host computer 21 has a voltage pin (Vbus) 2111, a D+ differential data pin 2113, a D− differential data pin 2115, and a ground pin (GND) 2117. The portable devices 25 can couple to the host computer 21 by connecting to the USB connector 233 or by coupling with the data transmitting device directly. Specifically, the portable devices 25 commonly connect the identical USB connector 211 of the host computer 21 logically.

Each of the portable devices 25, such as the (first) portable device 25a for example, comprises a switch circuit 252a and a switch 251. The switch circuit 252a is configured in portable device 25a. When turning on the portable device 25a and other portable devices are turned off) by switching the switch 251 of the portable device 25a, the switch 251 generates a control signal (Ctrl_a) to close the switch circuit 252a, so as to connect the data transmission path (via the differential data pins 2113, 2115) between the portable 25a device and the host computer 21 and obtain electricity provided by the host computer 21 via the voltage pin 2111. Similarly, the (second) portable device 25b or other portable device, which is parallel coupled with the data transmitting device 23 directly or via the USB connector 233, also has the same control circuit to switch voltage and differential data lines. That is, the (second) portable device 25b communicates with the host computer 21 when the data transmission path between the portable device 25a and the host computer 21 is disconnected, and the switch circuit 252b receives the control signal (Ctrl_b) to connect the data transmission path between the second portable device 25b and the host computer 21. There is only one of the portable devices 25 turned on at the same time, and other portable devices 25 must enter into off-line state.

In one embodiment, the switch circuit 252a comprises a PMOS transistor or a NMOS transistor. As shown in FIG. 2, the switch 251, configured in the portable devices 25, is switched directly to control the switch circuit 252a (or 252b) of the portable device 25a (or 25b) to connect or disconnect the data transmission path. In another embodiment, the switch 251 is a contacting switch which is used to generate the control signal by plugging a memory card 27 such as an SD card into the portable devices 25, but is not limited to this.

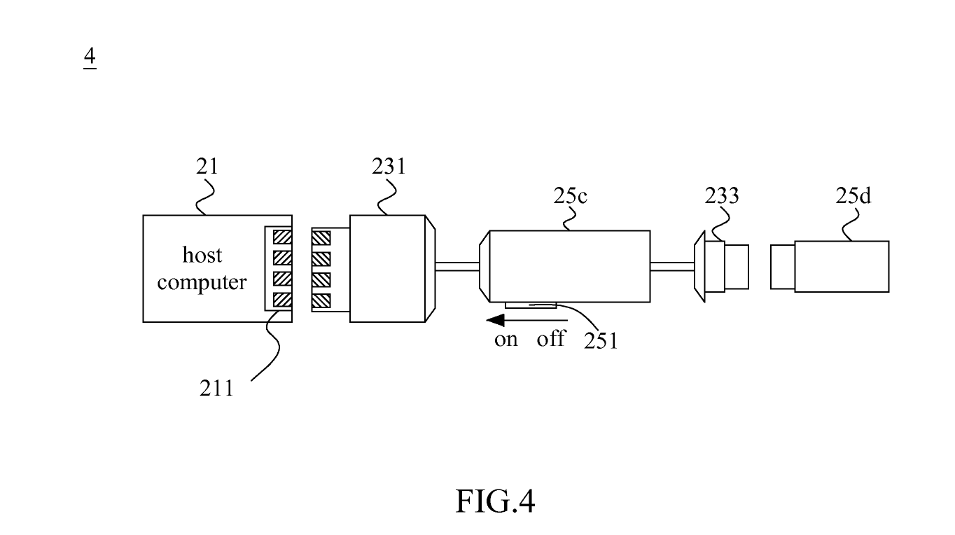

Referring now to FIG. 4, an architecture diagram illustrating a data transmitting system for portable device according to another embodiment of the present invention is shown. As illustrated, the (first) portable device 25c is coupled to the host computer 21 by connecting the USB connector 231 to the USB connector 211. However, the difference from the architecture in FIG. 2 is that the portable device 25c is coupling with the USB connector 231 and the at least one USB connector 233. At least one (second) portable device 25d can be coupled with the host computer 21 by connecting to the USB connector 233.

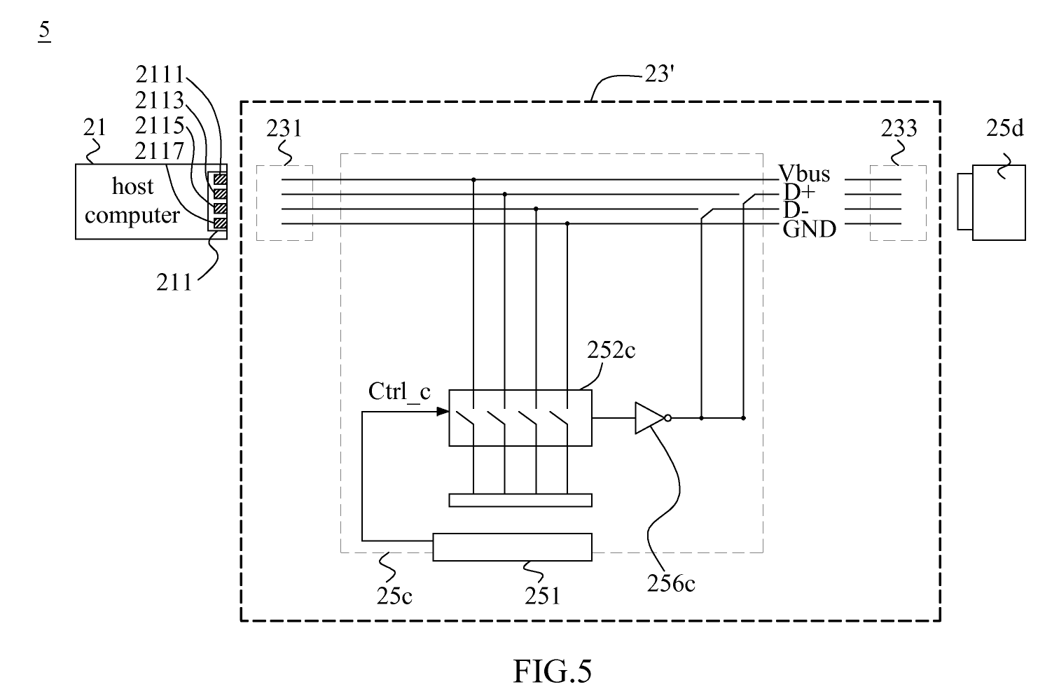

Please refer to FIG. 5 as well, which illustrates a circuit diagram of the data transmitting system 4 of FIG. 4 according to another embodiment of the present invention. In this embodiment, as shown, the data transmitting device 23′ includes the (first) USB connector 231, the (second) USB connector 233 and the first portable device 25c which is coupling with the USB connector 231 and the USB connector 233. When turning on the first portable device 25c by switching the switch 251 of the portable device 25c, the switch 251 generates a control signal (Ctrl_c) to close the switch circuit 252c, so as to connect the data transmission path (via the differential data pins 2113, 2115) between the portable device 25c and the host computer 21 and obtain electricity provided by the host computer 21 via the voltage pin 2111. However, the difference from the architecture in FIG. 3 is that the switch circuit cannot be configured inside the every portable device 25, for example, the portable device 25d, just like an ordinary portable device. The switch 251 controls the switch circuit 252c to couple the host computer 21 to the first portable device 25c or couple the host computer 21 to the second portable device 25d. When the second portable device 25d connecting with the USB connector 233, the second portable device 25d communicates with the host computer 21 when the switch circuit 252c receiving the control signal to connect the data transmission path between the USB connector 233 and the host computer 21. Because there is only one portable device occupying the at a time differential data pins 2113, 2115, the first portable device 25c is turned off by switching the switch 251 and then the second portable device 25d can transmit data with the host computer 21 via the differential data pins 2113, 2115. In one embodiment, the inverter 256c of the first portable device 25c outputs the control signal to close the switches between the second portable device 25d and the differential data pins 2113, 2115. Further, though the first portable device 25c is turned on and communicates with the host computer 21, the second portable device 25d still can be charged via the connected power line Vbus and ground line GND as shown in FIG. 5.

The data transmitting system of the present invention allows only one portable device 25 to communicate with the host computer at a time. In one embodiment, the data transmitting device further comprises a multiplexer configured to selectively couple the first portable device 25a or the second portable device 25b with the host computer 21 according to a select signal, so as to select one of the portable devices 25 to transmit data with the host computer 21 via the differential data pins 2113, 2115. Wherein, the select signal is generated according to the on/off states of all the portable devices 25.

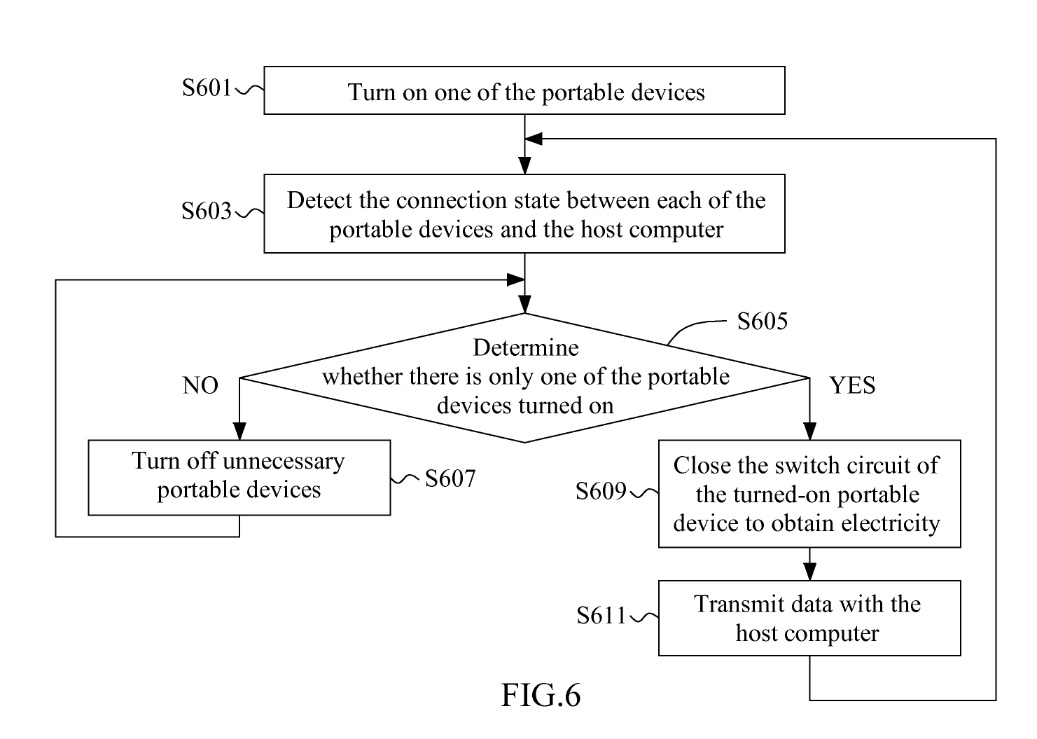

Finally, FIG. 6 shows a flow diagram illustrating a data transmitting method for portable device according to one embodiment of the present invention. Firstly, the user connects plural portable devices 25 with the USB connector 211 of the host computer 21 via a data transmitting device 23 (or 23′) and turns on any one of the portable devices 25 which are to be used in step S601. Then, in step S603, the host computer 21 detects the connection state between each of the portable devices 25 and the host computer 21. In one embodiment, the host computer 21 can charge the portable devices 25 coupled with the USB connector 233 of the data transmitting device 23 (or 23′) at this time.

In step S605, the host computer 21 determines whether there is only one of the portable devices 25 turned on. If not, it indicates that the at least two switch circuits of the portable devices 25 are closed to enable to occupy the differential data lines (pins 2113, 2115). Therefore, in step S607, unnecessary portable devices 25 must be turned off until there is only one portable device 25 staying the on-line state. That is, the data transmission paths between the host computer 21 and the unnecessary portable devices 21 are disconnected when not only one data transmission path between the host computer 21 and the portable devices 25 is connected. In one embodiment, the host computer 21 displays a warning window to notify users to turn off the unnecessary portable devices 25.

If determining that there is only one of the portable devices 25 turned on, the switch circuit of the turned-on portable device 25 is closed. Therefore, the portable device 25 obtains electricity provided by the host computer 21 via the voltage pin 2111 in step S609, and further transmits data with the host computer 21 via the differential data pins 2113, 2115 in step S611. When finishing the operation of the portable device 25, user can turn it off and turn on (or plug in) another portable device 25, and flow returns to step S603 to perform similarly control.

According to the above embodiment, the data transmitting system and method for portable devices, provided in the present invention, switches the switch circuit to communicate with the host computer by turning on the portable device. In this scheme, it can simply substitute for the USB hub by controlling to turn on only one portable device at a time. Accordingly, the present invention not only decreases system cost but also saves power consumption.

Although specific embodiments have been illustrated and described, it will be appreciated by those skilled in the art that various modifications may be made without departing from the scope of the present invention, which is intended to be limited solely by the appended claims.

What is claimed is:

1. A data transmitting device, comprising:
a first USB connector used to connect with a host computer;
at least one second USB connector; and
a first portable device coupling with the first USB connector and the second USB connector, comprising:
a switch circuit; and
a switch configured to generate a control signal to the switch circuit, so as to connect the data transmission path between the first portable device and the host computer or connect the data transmission path between the second USB connector and the host computer.

2. The data transmitting device of claim 1, further comprising:
a second portable device coupled with the host computer by connecting to the second USB connector;
wherein the second portable device communicates with the host computer when the switch circuit receives the control signal to connect the data transmission path between the second USB connector and the host computer.

3. The data transmitting device of claim 1, wherein the switch is a contacting switch used to generate the control signal by plugging a memory card into the first portable device.

4. The data transmitting device of claim 2, wherein the data transmitting device transmits power from the first USB connector connected with the host computer to charge the second portable device connected with the second USB connector.

5. The data transmitting device of claim 1 wherein the first portable device is a USB flash memory device, a card reader or a hard disk.

6. A data transmitting system, comprising:
a data transmitting device having a first USB connector, used to connect with a host computer, and at least one second USB connector; and
a first portable device coupling with the data transmitting device, comprising:
a first switch circuit; and
a first switch configured to generate a first control signal to the first switch circuit, so as to connect or disconnect the data transmission path between the first portable device and the host computer.

7. The system of claim 6, wherein the first portable device is connected to one of the second USB connectors to couple with the data transmitting device.

8. The system of claim 6, further comprising a second portable device connecting the second USB connector and charged by the host computer.

9. The system of claim 6, further comprising:
a second portable device coupled with the host computer by connecting to the second USB connectors, and the second portable device comprises:
a second switch circuit; and
a second switch configured to generate a second control signal to the second switch circuit, so as to connect or disconnect the data transmission path between the second portable device and the host computer;
wherein, the second portable device communicates with the host computer when the data transmission path between the first portable device and the host computer is disconnected and the second switch circuit receives the second control signal to connect the data transmission path between the second portable device and the host computer.

10. The system of claim 9, wherein the data transmitting device comprises a multiplexer configured to selectively couple the first portable device or the second portable device with the host computer according to the first control signal of the first switch and the second control signal of the second switch.

11. The system of claim 9, wherein the first switch or the second switch is a contacting switch, the first control signal or the second control signal is generated by plugging a memory card into the first portable device or the second portable device.

12. The system of claim 9, wherein the first portable device or the second portable device is a mobile phone, a personal digital assistant (PDA), a card reader, a USB flash disk (UFD), a hard disk or a mouse.

13. A data transmitting method for communicating one of a plurality of portable devices with a host computer via a data transmitting device having a plurality of USB connectors, and the method comprising:
configuring a switch circuit in each of the portable devices;
coupling at least one of the portable devices to the host computer by connecting the at least one of the portable devices to one of the USB connectors of the data transmitting device;
connecting at least one data transmission path between the host computer and the portable devices by the switch circuits of the portable devices; and
transmitting data between the portable device and the host computer when only one data transmission path between the host computer and the portable devices is connected by the switch circuit of the portable device.

14. The method of claim 13, further comprising:
disconnecting one of the data transmission paths between the host computer and the portable devices by one of the switch circuits when not only one data transmission path between the host computer and the portable devices is connected.

15. The method of claim 13, wherein the portable device connected with the USB connector comprises a switch, and the step of connecting the data transmission path comprising:
switching the switch to control the switch circuit of the portable device to connect or disconnect the data transmission path.

16. The method of claim 13, wherein the portable device connected with the USB connector comprises a contacting switch, and the step of connecting the data transmission path comprising:
plugging a memory card into the portable device; and
connecting the data transmission path by providing a control signal to the switch circuit from the contacting switch.

17. The method of claim 13, further comprising:
charging the portable device when the portable device connecting with the USB connector of the data transmitting device.

18. A data transmitting method for communicating one of a plurality of portable devices with a host computer via a data transmitting device having a plurality of USB connectors, and the method comprising:
configuring a switch circuit in one of the portable devices;
coupling the portable device having the switch circuit with the data transmitting device; and
connecting a data transmission path between the host computer and the portable device having the switch circuit by the switch circuit to transmit data between the portable device having the switch circuit and the host computer, or connecting the data transmission path between the USB connector, which is not connecting with the portable device having the switch circuit, and the host computer by the switch circuit.

19. The method of claim 18, wherein the portable device having the switch circuit comprises a switch, and the step of connecting the data transmission path comprising:
switching the switch to control the switch circuit to connect the data transmission path between the host computer and the portable device having the switch circuit or to connect the data transmission path between the USB connector, which is not connecting with the portable device having the switch circuit, and the host computer.

20. The method of claim 18, wherein the portable device having the switch circuit comprises a contacting switch, and the step of connecting the data transmission path comprising:
plugging a memory card into the portable device; and
connecting the data transmission path between the host computer and the portable device having the switch circuit by providing a control signal to the switch circuit from the contacting switch.
